(19) United States
(12) Patent Application Publication
(10) Pub. No.: US 2016/0012082 A1
(43) Pub. Date: Jan. 14, 2016

(54) CONTENT-BASED REVISION HISTORY TIMELINES

(71) Applicant: Adobe Systems Incorporated, San Jose, CA (US)

(72) Inventor: Rajorshi Ghosh Choudhury, New Delhi (IN)

(73) Assignee: Adobe Systems Incorporated, San Jose, CA (US)

(21) Appl. No.: 14/326,902

(22) Filed: Jul. 9, 2014

(51) Int. Cl. G06F 17/30; G06F 17/22

(52) U.S. Cl. CPC G06F 17/30303; G06F 17/2288; G06F 17/30011

(57) ABSTRACT

A document management system associates content provided within a managed document with a content-based revision history timeline. Multiple documents may be associated with the timeline, wherein each of the documents contains content that is nearly duplicative with respect to content contained in at least one other associated document. Content items can be considered to be nearly duplicative based on an evaluation of resemblance and containment of a set of shingles derived from each content items. If no nearly duplicative content is detected, a new revision history timeline is created. The resulting revision history timelines can be rendered in response to certain user commands, such as document check-out from the document management system, thereby providing users with a visual understanding of how content contained within a given document relates to content contained in other documents managed by the document management system.

### FIELD OF THE INVENTION

This disclosure relates generally to electronic document management systems, and more specifically to techniques for identifying electronic documents having nearly duplicative content and generating a revision history timeline for such content.

### BACKGROUND

Computers and electronic documents have become an increasingly indispensable part of modern life. In particular, electronic documents, which serve as virtual storage containers for binary data, have gained acceptance not only as a convenient replacement for conventional paper documents, but also as a useful way to store a wide variety of digital assets such as multimedia assets, webpages, financial records, and electronic correspondence. The increased use of electronic documents has resulted in the adaptation of conventional paper-based document processing workflows to the electronic realm. As a result, a wide variety of software applications have been developed to facilitate the process of managing electronic documents and the workflows in which such documents are used. Examples of such applications include electronic document management systems and content management systems, both of which can store and track the revision history of a collection of electronic documents from a central interface. Content management systems also often provide procedures for managing workflows that use the aforementioned digital assets in a collaborative environment. Such workflow management may include designating user groups which are granted rights to take certain actions with respect to one or more electronic documents. Examples of commercially available content management systems include Adobe Experience Manager (Adobe Systems Incorporated, San Jose, Calif.) and Microsoft SharePoint (Microsoft Corporation, Redmond, Wash.).

### BRIEF DESCRIPTION OF THE DRAWINGS

FIG. 1 is a block diagram schematically illustrating selected components of a networked computer system that can be used to implement certain of the embodiments disclosed herein.

FIG. 2 is a flowchart illustrating an example method for identifying electronic documents having nearly duplicative content and generating a revision history timeline for such content.

FIGS. 3A and 3B comprise a flowchart illustrating an example method for adding a new document to a document repository that is managed by a document management system configured to maintain a revision history timeline for documents stored in the document repository.

FIG. 4 is a flowchart illustrating an example method for adding a modified version of a document to a document repository that is managed by a document management system configured to maintain a revision history timeline for documents stored in the document repository.

FIG. 5 is a flowchart illustrating an example method for removing a document from a document repository that is managed by a document management system configured to maintain a revision history timeline for documents stored in the document repository.

FIG. 6 illustrates three intersecting content-based revision history timelines such as may be generated using certain of the techniques disclosed herein.

FIG. 7 is a flowchart illustrating an example method for tracking content revision history.

### DETAILED DESCRIPTION

Existing electronic document management systems and content management systems provide a wide range of tools which help users manage and interact with content items stored in an electronic content repository. However, despite the variety and complex nature of such tools, the process of locating a particular desired piece of information within a content repository still often presents significant challenges. Furthermore, merely locating a particular document does not necessarily provide knowledge with respect to how content provided within that document relates, if at all, to content stored in other documents. More generally, existing document management systems often rely on a document-based approach to organizing content that provides robust version control of a particular document, but that lacks the ability to reliably detect and present information with respect to how content provided in two different documents might be related. This inability to link content in different documents is especially problematic where different versions of content may appear to the document management system as distinct files originating from different sources. This may occur, for example, where a first version of a document is downloaded from a cloud-based storage repository, a second version is received via email, and a third version copied from a universal serial bus (USB) flash memory drive. In this case, a user would be required to manually apply version control to the individual documents, which relies not only on the user's diligence, but also on the user's accurate tracking of which documents have related content. The resulting high likelihood of user error makes this solution highly unsatisfactory.

Thus, and in accordance with certain of the embodiments disclosed herein, techniques are provided for automatically identifying electronic documents having nearly duplicative content and generating a revision history timeline for such content. For example, in certain embodiments a document management system can be configured to associate content provided within a managed document with a content-based revision history timeline. Multiple documents may be associated with the timeline, wherein each of the documents contains content that is nearly duplicative with respect to content contained in at least one other associated document. When the document management system receives a new document, the content within that document is parsed and compared with other content managed by the document management system. Where nearly duplicative content is detected, documents containing such content are grouped together in the same revision history timeline. If no nearly duplicative content is detected, a new revision history timeline is created.

When the document management system receives an updated version of an existing document, the existing document is removed from any existing revision history timelines and the new version is parsed and analyzed as a new document. This may occur, for example, where a user checks-out a document, modifies it, and checks-in the modified version of the document. The document management system recognizes that an updated version of the document has been received as a result of the same document being checked-in and checked-out. In this case, the older version of the document is removed from existing timelines so that the timelines reflect content-based relationships based on the most recent version of the documents managed by the document management system. This avoids confusion where a document modification causes the most recent version of a given document to no longer relate to another managed document, thereby severing the content-based relationship. In an alternative embodiment, revision history timelines can be generated on the basis of older document versions which are archived by the document management system.

Document metadata, such as creation and modification times, can be used to arrange multiple documents on a single timeline in a logical way. The resulting revision history timelines can be rendered in response to certain user commands, such as document check-out from the document management system, thereby providing users with a visual understanding of how content contained within a given document relates to content contained in other documents managed by the document management system. Numerous configurations and variations of the content-based revision history timelines disclosed herein will be apparent in light of this disclosure.

The disclosed content revision history timelines provide several advantages with respect to existing electronic document management systems and content management systems. In particular, the solutions disclosed herein recognize that users often produce multiple versions of a single document when creating content. This may occur, for example, as a result of working at separate home and office computers, exchanging revised versions of a document via email, renaming works-in-progress, and exporting different versions of a document to different file formats. Existing systems emphasize tracking of file operations performed on a particular document and therefore do not necessarily recognize differently named files or differently formatted files as containing related content. In contrast, certain of the disclosed embodiments allow a content revision history timeline to be derived based on detecting nearly duplicative content existing in a variety of locations, such as a cloud-based storage repository, an email server, and one or more client-based local storage devices. And as part of this analysis, content can be extracted from a variety of file types, including word processing files, email files, hypertext markup language (HTML) files, text files, and portable document format (PDF) files. This broad-based approach of detecting a wide variety of different content types from a wide variety of different content sources increases content discoverability and allows a more robust content history to be derived. For example, in certain embodiments a document management system is configured to detect nearly duplicative content from several different storage resources without user intervention, therefore providing a more reliable user experience than existing systems that require manual version control of documents downloaded from, for example, an email server or a cloud-based sharing service. Ultimately, this enables users to accurately trace the evolution of content across different files and media repositories, thereby producing a content revision history rather than a document revision history.

As used herein, the term “content” refers, in addition to its ordinary meaning, to information intended for direct or indirect consumption by a user. For example, the term content encompasses information directly consumed by a user such as when it is displayed on a display device or printed on a piece of paper. The term content also includes information that is not specifically intended for display, and therefore also encompasses items such as software, executable instructions, scripts, hyperlinks, addresses, pointers, metadata, and formatting information. The use of the term content is independent of (a) how the content is presented to the user for consumption and (b) the software application used to create or render the content. The term “digital content” refers to content which is encoded in binary digits (for example, zeroes and ones). In the context of applications involving digital computers, the terms “content” and “digital content” are often used interchangeably.

As used herein the term “document” refers, in addition to its ordinary meaning, to an electronic container used to store a collection or subset of content. It will be appreciated that content can be stored according to a wide variety of different formats which dictate the type of document used to store the content. Examples of such formats include word processing documents, textual documents, HTML documents, and PDF documents. A document may include not only the aforementioned content itself, but also metadata describing certain aspects of the content, such as a creation timestamp, a modification timestamp, or author identification information. A document can take the form of a physical object, such as one or more papers containing printed information, or in the case of an “electronic document”, a non-transitory computer readable medium containing digital data. Electronic documents can be rendered in a variety of different ways, such as via display on a screen, by printing using an output device, or aurally using an audio player and text-to-speech software. Documents may thus be communicated amongst users by a variety of techniques ranging from physically moving papers containing printed matter to wired or wireless transmission of digital data. The terms “document” and “file” may be used interchangeably, although the term “document” is more often used to refer to containers of text-based content.

As used herein the terms “document management system” and “content management system” refer, in addition to their respective ordinary meanings, to systems that can be used in an online environment to generate, modify, publish, or maintain content that is stored in a data repository. Content management systems and document management systems can therefore be understood as providing functionalities which are particularly adapted for workflow management in an online environment, including content authoring and publication functionality for websites, software applications, and mobile applications. These functionalities, which may be provided by one or more modules or sub-modules that form part of the overarching system, may be further adapted to allow multiple users to work collaboratively with the managed content. Such systems can be used to manage a wide variety of different types of content, including textual content, graphical content, multimedia content, executable content, and application user interface elements. Content management systems and document management systems are often implemented in a client-server computing environment that allows a plurality of different users to access a central content repository where the managed content is stored.

As used herein, the term “nearly duplicative” describes a first content item which resembles a second content item, or which is roughly contained within the second content item. The concepts of “resemblance” and “containment” can be quantified according to any suitable algorithm. For example, in one embodiment the resemblance r_{w}(A, B) of Document A and Document B is a number between zero and one such that when the resemblance is close to one, it is likely that the documents are roughly the same. Likewise, the containment c_{w}(A, B) can be understood as a number between zero and one such that when the containment is close to one, it is likely that Document A is roughly contained within Document B. In certain embodiments the resemblance r_{w}(A, B) and containment c_{w}(A, B) of Document A and Document B can be quantified as

$$\begin{matrix}{r}_{w} ( A , B ) = \frac{\vert S ( A , w ) ⋂ S ( B , w ) \vert}{\vert S ( A , w ) ⋃ S ( B , w ) \vert} , \\ and & ( 1 ) \\ {c}_{w} ( A , B ) = \frac{\vert S ( A , w ) ⋂ S ( B , w ) \vert}{\vert S ( A , w ) \vert} . & ( 2 )\end{matrix}$$

Likewise the containment c_{w}(B, A), which represents the likelihood that Document B is roughly contained within Document A, can be quantified as

$${c}_{w} ( B , A ) = \frac{\vert S ( A , w ) ⋂ S ( B , w ) \vert}{\vert S ( B , w ) \vert} . \qquad ( 3 )$$

Here S(A, w) and S(B, w) refer to the set of shingles in Document A and Document B, respectively, where each shingle is of size w. Thus it will be appreciated that the parameters r_{w}(A, B) and c_{w}(A, B) allow the degree to which Document A and Document B are nearly duplicative to be quantified.

As used herein, the term “shingle” refers, in addition to its ordinary meaning, to a contiguous subsequence of tokens contained within a given document. More specifically, a given document can be understood as a sequence of countable tokens that may comprise letters, words, lines, or any other appropriate document fragment. A contiguous subsequence of such tokens is a “shingle”. Thus, for a given Document A, a set of shingles S(A, w) can be generated, where w is the size of each shingle. For example, if Document A comprises the words:

A=a rose is a rose is a rose, (4)

then the w-shingling of Document A, where w=4, is the bag

{(a, rose, is, a),(rose, is, a, rose),(is, a, rose, is),(a, rose, is, a),(rose, is, a, rose)}. (5)

The set of shingles S(A, 4) can be defined as the set of shingles in Document A, where each shingle is of size w=4. The 4-shingling of Document A produced a bag of five shingles, but only there of these shingles are unique. Thus

S(A,4)={(a, rose, is a),(rose, is, a, rose),(is, a, rose, is)}. (6)

A set of shingles can be understood as a condensed fingerprint or sketch of a larger document that still provides useful insight regarding the content contained within the larger document. Additional details regarding the definition of document resemblance, document containment, and shingling are provided by Andrei Z. Broder, “On the resemblance and containment of documents”, Compression and Complexity of Sequences 1997 Proceedings, pages 21-29 (June 1997).

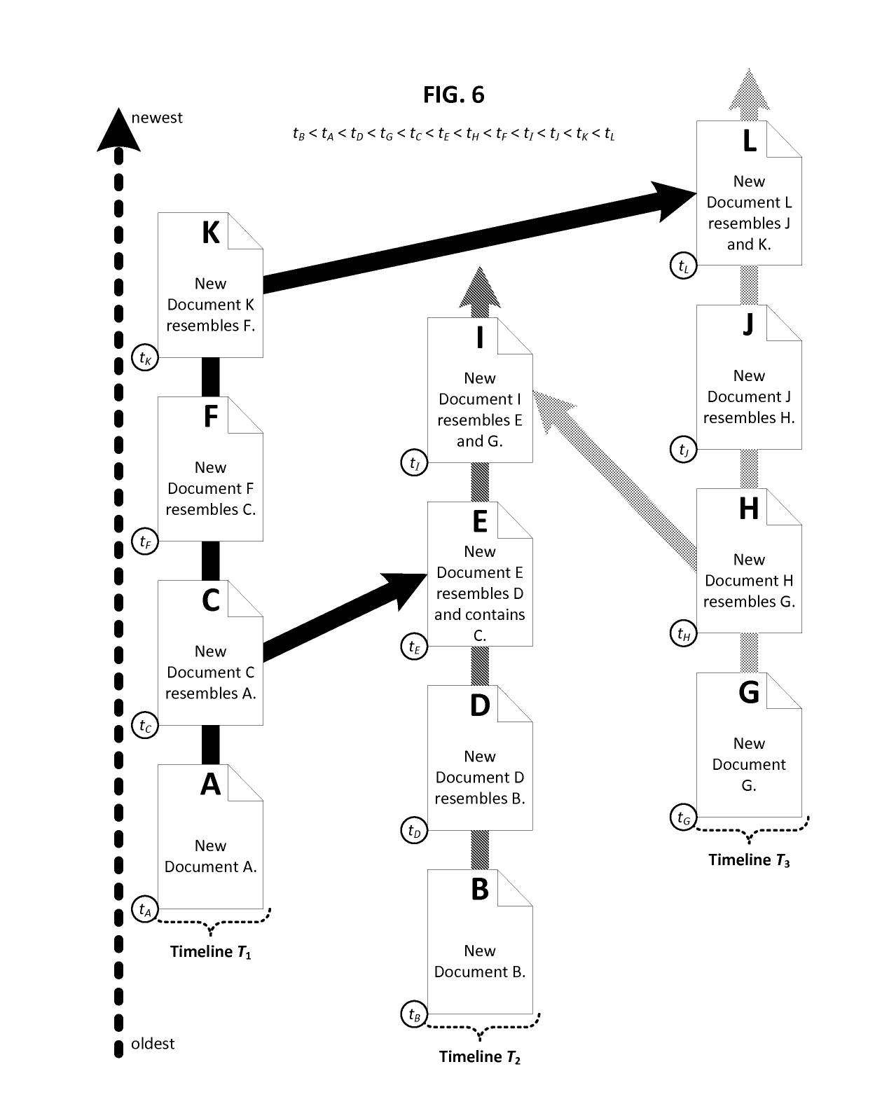

As used herein, the term “revision history timeline” refers, in addition to its ordinary meaning, to a graphical, a textual, or a graphical and textual representation of the evolution of content over time. A revision history timeline may also be represented by metadata or other information stored in computer memory, and thus need not be rendered graphically or textually at a given point in time. The evolved content can be stored in a document, for example. Thus, in one embodiment a revision history timeline includes a linear time axis with notations indicating one or more time points corresponding to receipt, check-in or other manipulations of a document. A revision history timeline may include a plurality of documents, such as where nearly duplicative content appears in several different documents, such as in a word processing document, an email, and a journal entry. Multiple revision history timelines can intersect, such as may occur where a single document contains content that is nearly duplicative of content contained within two different documents which are included in two different timelines. An example graphical representation of three interesting revision history timelines is illustrated in FIG. 6.

System Architecture

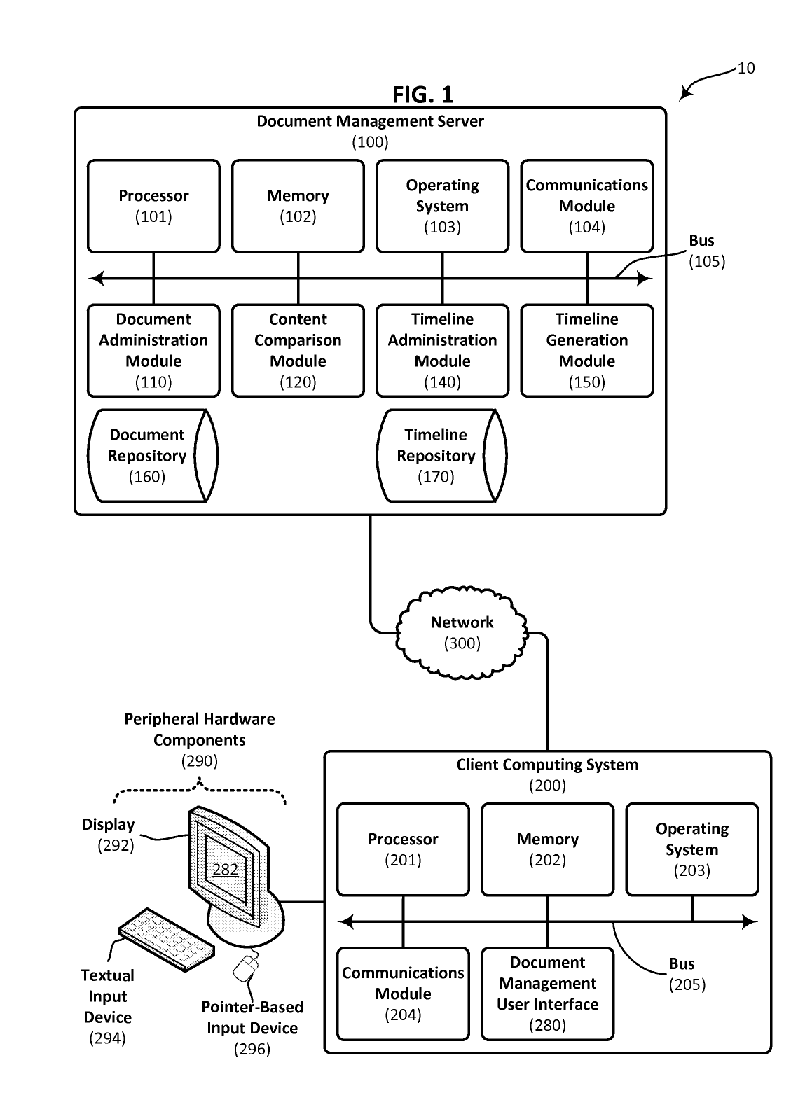

FIG. 1 is a block diagram schematically illustrating selected components of a networked computer system 10 that can be used to implement certain of the embodiments disclosed herein. Such embodiments can be understood as involving a series of interactions between a document management server 100 and a client computing system 200 that occur via a network 300. The architecture and functionality of the variations components and subcomponents comprising networked computer system 10 will be described in turn. However, in general, it will be appreciated that such embodiments provide techniques for identifying electronic documents having nearly duplicative content and generating a revision history timeline for such content. Because the particular functionality provided in a given implementation may be specifically tailored to the demands a particular application, this disclosure is not intended to be limited to provision or exclusion of any particular resources, components, or functionality.

In one embodiment document management server 100 comprises an array of enterprise class devices configured to host documents, respond to client requests for hosted documents, and manage workflows that manipulate the hosted documents. In an alternative embodiment document management server 100 comprises a personal computer capable of providing content management functionality to one or more client computing systems 200 connected to a home or office network. In general, the hosted documents can be obtained from a wide range of networked or local document sources, including from client computing system 200. Other configurations for document management server 100 can be implemented in other embodiments. Client computing system 200, on the other hand, can be understood as comprising any of a variety of computing devices that are suitable for interaction with document management server 100, wherein such interaction includes both generation of new documents, as well as review and modification of existing documents. For example, depending on the demands and use context of a particular implementation, client computing system 200 may comprise a device such as a handheld computer, a cellular telephone, a tablet computer, a smartphone, a laptop computer, a desktop computer, a digital media player, or a set-top box. A combination of different devices can be used in alternative embodiments.

Thus, in general it will be appreciated that document management server 100 and client computing system 200 can be configured so as to provide a client-server computing environment in which the various embodiments disclosed herein can be implemented. For example, document management server 100 and client computing system 200 can be configured to communicate with each other via network 300, which may be a local area network (such as a home-based or office network), a wide area network (such as the Internet), or a combination of such networks, whether public, private, or both. Access to resources on a given network or computing system may require credentials such as usernames, passwords, or any other suitable security mechanism. For instance, in one embodiment networked computer system 10 comprises a globally distributed network of tens, hundreds, thousands, or more document management servers 100 capable of delivering hosted documents over a network of secure communication channels to an even larger number of client computing systems 200.

In accordance with the foregoing, document management server 100 and client computing system 200 each include one or more software modules configured to implement the various functionalities disclosed herein, as well as hardware that enables such implementation. Examples of enabling hardware include a processor 101, 201; a memory 102, 202; a communications module 104, 204; and a bus 105, 205. An example of one type of implementing software is an operating system 103, 203. Document management server 100 and client computing system 200 are coupled to network 300 to allow for communications with each other, as well as with other networked computing devices and resources, such as a dedicated graphics rendering server or a cloud-based storage repository. Document management server 100 and client computing system 200 can be local to network 300 or remotely coupled to network 300 by one or more other networks or communication channels.

Processor 101, 201 can be any suitable processor, and may include one or more coprocessors or controllers, such as a graphics processing unit or an audio processor, to assist in control and processing operations associated with document management server 100 and client computing system 200. Memory 102, 202 can be implemented using any suitable type of digital storage, such as one or more of a disk drive, a redundant array of independent disks (RAID) a universal serial bus (USB) drive, flash memory, random access memory, or any suitable combination of the foregoing. Thus in certain embodiments memory 102, 202 comprises a distributed system of multiple digital storage devices. In the context of document management server 100, memory 102 can be used to store a document repository 160 and a timeline repository 170. Document repository 160 provides a storage resource for documents managed by document management server 100. Timeline repository 170 comprises a data structure that correlates a given document (for instance, example Document A) with a revision history timeline (for instance, timeline T₀), wherein the given document is represented by a set of shingles (for instance, S(A, w)). The organizational structure of an example implementation of timeline repository 170 will be described in turn.

Operating system 103, 203 may comprise any suitable operating system, such as Google Android (Google, Inc., Mountain View, Calif.), Microsoft Windows (Microsoft Corp., Redmond, Wash.), or Apple OS X (Apple Inc., Cupertino, Calif.). As will be appreciated in light of this disclosure, the techniques provided herein can be implemented without regard to the particular operating system provided in conjunction with document management server 100 or client communicating system 200, and therefore may also be implemented using any suitable existing or subsequently-developed platform. Communications module 104, 204 can be any appropriate network chip or chipset which allows for wired or wireless connection to network 300 and other computing devices and resources. Communications module 104, 204 can also be configured to provide intra-device communications via bus 105, 205.

Still referring to the example embodiment illustrated in FIG. 1, document management server 100 includes a document administration module 110 that is configured to receive instructions from client computing system 200 with respect to the addition, modification, and removal of documents from one or more content-based revision history timelines. In particular, document administration module 110 can be configured to receive a command from client computing system 200 and apply an appropriate revision history timeline workflow based on such command. Document administration module 100 can also be configured to parse a given document into a set of shingles. A content comparison module 120 can then be used to compare two sets of shingles for two respective documents to determine a degree of resemblance and containment between the two documents.

In certain embodiments document management server 100 also includes a timeline administration module 140 and a timeline generation module 150. Timeline administration module 140 is configured to associate a new or modified document with a selected revision history timeline based on a degree of similarity between the new or modified document and an existing document included in the revision history timeline. In such embodiments a document associated with a particular revision history timeline will be nearly duplicative of at least one other document included in the timeline. Timeline administration module 140 is also configured to remove documents from a revision history timeline as appropriate. Timeline generation module 150 is configured to generate a graphical representation of a revision history timeline based on the documents associated with the timeline and metadata corresponding to such documents. For example, document creation and modification times can be used to arrange multiple documents on a single timeline in a logical way. Such a graphical representation is optionally provided to client computing system 200 for review and analysis by a user.

Referring still to the example embodiment illustrated in FIG. 1, client computing system 200 includes a document management user interface 280 that facilitates authoring and manipulation of documents managed by document management server 100, such as those stored in document repository 160. Document management user interface 280 can be provided by a wide range of software applications, including applications installed and executing locally on client computing system 200. Such software applications may include, for example, word processing applications, spreadsheet applications, presentation applications, and web content publishing applications. Document management user interface 280 is optionally configured to integrate functionality provided by document management server 100, for example such that documents can be checked-in or checked-out of document repository 160 directly from a content editor provided by document management user interface 280. In addition, such integration allows a revision history timeline that is generated by timeline generation module 150 to be received and rendered by document management user interface 280. Thus a user who checks-in or checks-out a document can be presented with a revision history timeline associated with that document via the same interface used to substantively interact with the document.

In certain embodiments document management user interface 280 is configured to generate a graphical user interface 282 which can be implemented with, or otherwise used in conjunction with, one or more suitable peripheral hardware components 290. In such embodiments peripheral hardware components 290 are coupled to or otherwise form part of client computing system 200. Examples of such components include a display 292, a textual input device 294 (such as a keyboard), and a pointer-based input device 296 (such as a mouse). One or more additional or alternative input/output devices, such as a touch sensitive display, a speaker, or a microphone can be used in alternative embodiments. While document management user interface 280 is illustrated in FIG. 1 as being installed local to client computing system 200, in an alternative embodiment at least some of the functionality associated with document management user interface 280 is provided to client computing system 200 using an applet (for example, a JavaScript applet) or other downloadable module. Such a remotely-provisioned module can be provided in real-time in response to a request from client computing system 200 for access to document management server 100 or other resources that are of interest to the user of client computing system 200. Examples of such other resources include a cloud-based document repository. In any such standalone or networked computing scenarios, document management user interface 280 can be implemented with any suitable technologies that allow a user to interface with networked computer system 10.

The embodiments disclosed herein can be implemented in various forms of hardware, software, firmware, or special purpose processors. For example, in one embodiment a non-transitory computer readable medium has instructions encoded thereon that, when executed by one or more processors, allow electronic documents having nearly duplicative content to be identified, and further allow a revision history timeline for such content to be generated. The instructions can be encoded using one or more suitable programming languages, such as C, C++, object-oriented C, JavaScript, Visual Basic .NET, BASIC, or alternatively, using custom or proprietary instruction sets. Such instructions can be provided in the form of one or more computer software applications or applets that are tangibly embodied on a memory device, and that can be executed by a computer having any suitable architecture. In one embodiment the system can be hosted on a given website and implemented using JavaScript or another suitable browser-based technology.

The functionalities disclosed herein can optionally be incorporated into a variety of different software applications, such as word processing applications, desktop publishing applications, presentation applications, and web content editing applications. For example, a word processing application can be configured to display a content-based revision history timeline in response to a user command to open a document managed by a document management server. In such embodiments the word processing application can therefore be configured to implement certain of the functionalities disclosed herein to facilitate generation and display of a revision history timeline. The computer software applications disclosed herein may include a number of different modules, sub-modules, or other components of distinct functionality, and can provide information to, or receive information form, still other components and services. These modules can be used, for example, to communicate with peripheral hardware components 290, networked storage resources, or other external components. In particular, other components and functionality not reflected in the illustrations will be apparent in light of this disclosure, and it will be appreciated that the present disclosure is not intended to be limited to any particular hardware or software configuration. Thus in other embodiments the components illustrated in FIG. 1 may comprise additional, fewer, or alternative subcomponents.

The aforementioned non-transitory computer readable medium may be any suitable medium for storing digital information, such as a hard drive, a server, a flash memory, or random access memory. In alternative embodiments the computer and modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that the present disclosure is not intended to be limited to any particular system architecture.

Methodology and User Interface

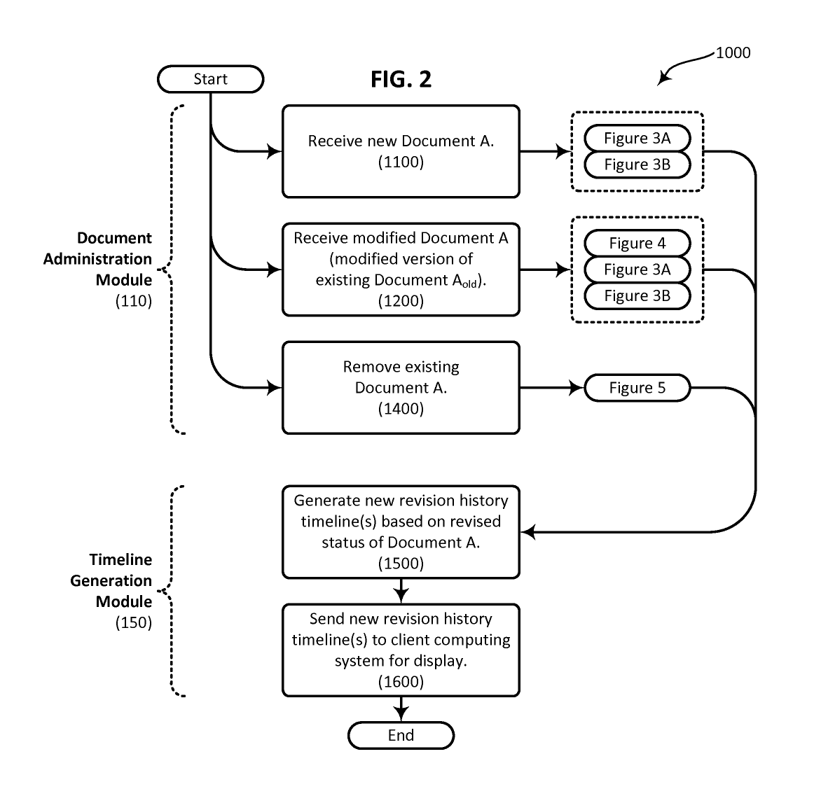

FIG. 2 is a flowchart illustrating an example method 1000 for identifying electronic documents having nearly duplicative content and generating a revision history timeline for such content. As can be seen, revision history timeline method 1000 includes a number of phases and sub-processes, the sequence of which may vary from one embodiment to another. However, when considered in the aggregate, these phases and sub-processes form a complete revision history timeline method that is responsive to user commands in accordance with certain of the embodiments disclosed herein. This method can be implemented, for example, using the system architecture illustrated in FIG. 1. However other system architectures can be used in other embodiments, as will be apparent in light of this disclosure. To the end, the correlation of the various functionalities shown in FIG. 2 to the specific components illustrated in FIG. 1 is not intended to imply any structural or use limitations. Rather, other embodiments may include varying degrees of integration where multiple functionalities are performed by one system or by separate systems. For instance, in an alternative embodiment a single module can be used to process a document and generate a content revision history timeline that includes the processed document. Thus other embodiments may have fewer or more modules and sub-modules depending on the granularity of implementation. Numerous variations and alternative configurations will be apparent in light of this disclosure.

Still referring to FIG. 2, method 1000 commences with document administration module 110 responding to a user command with respect to an example Document A. In one implementation, the user command corresponds to a request to store a newly-created Document A in document repository 160. See reference numeral 1100 in FIG. 2. This may occur, for example, where a user authors a new document using resources available to client computing system 200. In another implementation, the user command corresponds to a request to store a modified Document A in document repository 160, wherein Document A is a modified version of existing Document A_{old}. See reference numeral 1200 in FIG. 2. This may occur, for example, where a user checks-out Document A_{old} from document repository 160, modifies it using resources available to client computing system 200, and then attempts to check-in the resulting modified Document A. In yet another implantation, the user command corresponds to a request to remove an existing Document A from document repository 160. See reference numeral 1400 in FIG. 2. While FIG. 2 illustrates three example commands that can trigger certain of the functionality disclosed herein, it will be appreciated that other commands, such as document viewing commands, document property manipulation commands, and document transmission commands can each trigger such functionality as well. For example, in an alternative embodiment when a user invokes a command to email an example Document A, a method for generating a content-based revision history timeline for Document A can be initiated.

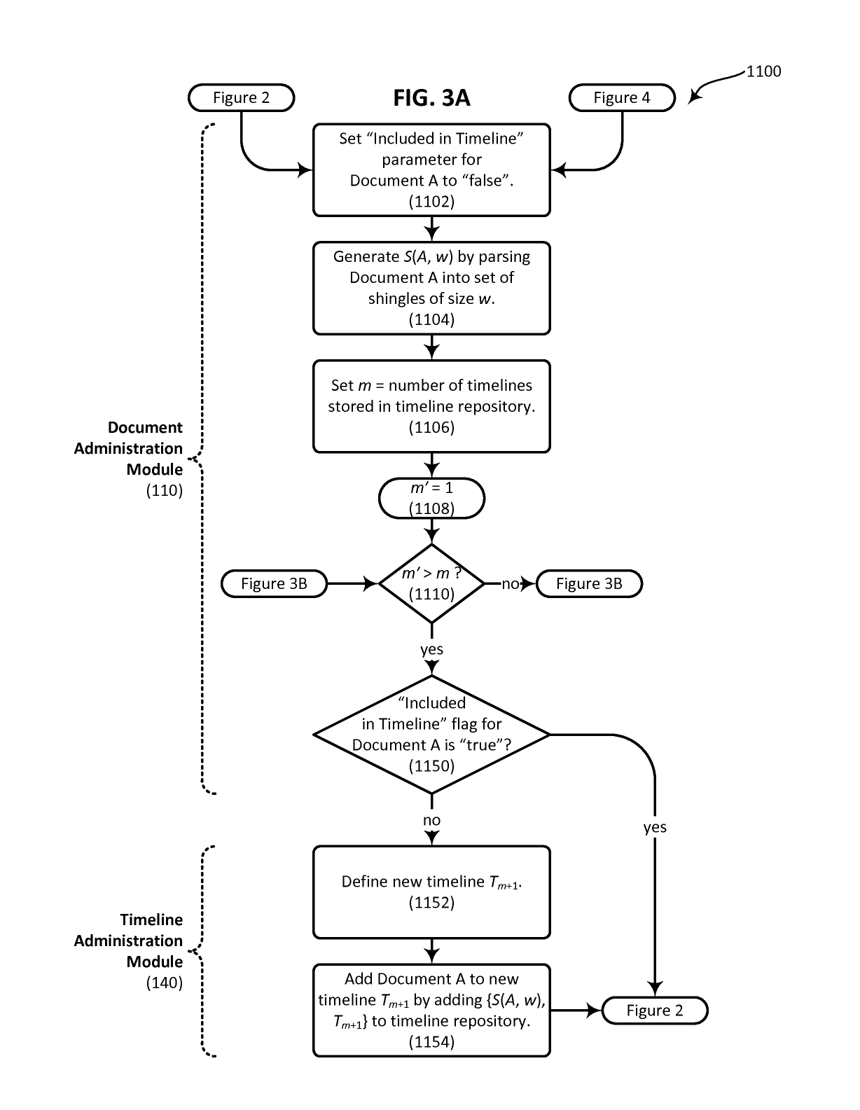

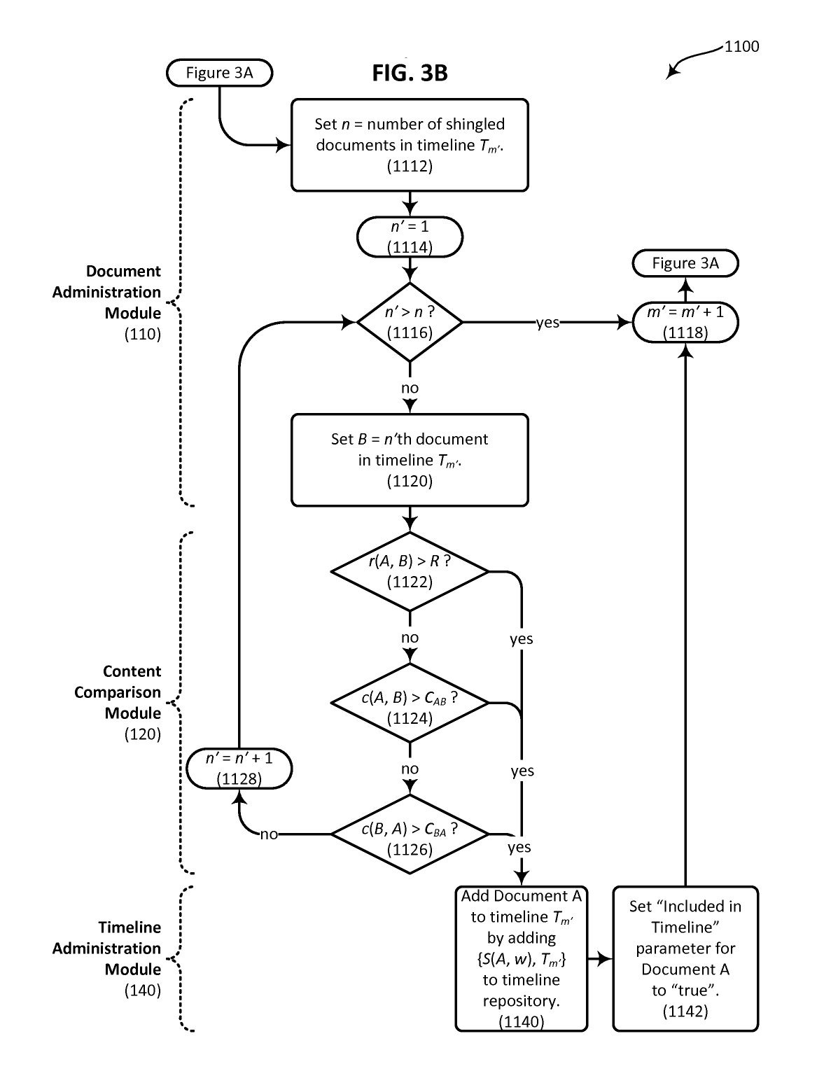

FIGS. 3A and 3B comprise a flowchart illustrating an example method 1100 for adding a new document to document repository 160, wherein document management system 100 is configured to maintain a revision history timeline for documents stored in document repository 160. In the context of method 1100, the newly received document will be referred to as “Document A”. Because Document A is processed as a newly-created document, at the outset of method 1100 it can be assumed that Document A is not included in an existing revision history timeline. An “Included in Timeline” parameter associated with Document A can therefore be set to “false” when method 1100 commences. See reference numeral 1102 in FIG. 3A.

Method 1100 also commences with using document administration module 110 to parse Document A into set of unique shingles S(A, w), where w is the shingle size. See reference numeral 1104 in FIG. 3A. The shingle size w can be selected based on the demands of a particular application, wherein a smaller shingle size will generally result in a lower threshold for establishing that two documents are nearly duplicative. Thus the shingle size w can be understood as providing a user-adjustable margin of error parameter that affects whether two documents are considered nearly duplicative. In one embodiment the shingle size w falls within a range from about five words to about five hundred words; in another embodiment the shingle size w falls within a range from between about ten words to about one hundred words; and in yet another embodiment the shingle size w falls within a range from about twenty words to about forty words. In one particular embodiment the shingle size w is about thirty words. In certain embodiments the shingle size w is proportional to a typical length of document to be analyzed, such that a system configured to analyze longer documents is configured to parse the documents based on a larger shingle size. In alternative embodiments the shingle size w can be measured in a unit other than words, such as in a quantity of characters or syllables. In some cases the “Included in Timeline” parameter is set to “false” after or while newly-received Document A is parsed into a set of unique shingles S(A, w).

As described herein, timeline repository 170 comprises a data structure that correlates a given existing document (for instance, Document B) with a revision history timeline (for instance, timeline T₀), wherein the given existing document is represented by a set of shingles (for instance, S(B, w)). This correlation can be represented by a data pair such as {S(B, w), T₀}, several of which can be stored in timeline repository 170. Thus timeline repository 170 can be understood as storing m distinct timelines. See reference numeral 1106 in FIG. 3A. To enable stepwise analysis of timelines stored in timeline repository 170, the quantity m can be compared to a timeline counting parameter m′ which is initially set such that m′=1. See reference numeral 1108 in FIG. 3A. It can then be determined whether m′>m. See reference numeral 1110 in FIG. 3A. If not, timeline T_{m′} is analyzed, as illustrated in FIG. 3B.

Timeline T_{m′} can be understood as including n existing documents, each of which is represented by a set of shingles (for instance, S(B, w)). See reference numeral 1112 in FIG. 3B. To enable stepwise analysis of the documents included in timeline T_{m′}, the quantity n can be compared to a document counting parameter n′ which is initially set such that n′=1. See reference numeral 1114 in FIG. 3B. It can then be determined whether n′>n. See reference numeral 1116 in FIG. 3B. If not, then newly-received Document A can be compared to an existing Document B, wherein Document B is the n'th document in timeline T_{m′}. See reference numeral 1120 in FIG. 3B. In such embodiments this comparison provides a determination of whether newly-received Document A is nearly duplicative of existing Document B. In one embodiment this determination is based on one or more calculations that quantify the resemblance and containment of Documents A and B. These calculations can be performed by content comparison module 120.

For example, the resemblance of newly-received Document A with existing Document B can be quantified by the parameter r_{w}(A, B), as provided by Equation (1). If the resemblance r_{w}(A, B) is greater than a threshold resemblance parameter R, then Documents A and B can be considered to be nearly duplicative of each other. See reference numeral 1122 in FIG. 3B. The threshold resemblance parameter R can be selected based on the demands of a particular application, wherein a smaller value R will result in a lower threshold for establishing that Documents A and B are nearly duplicative. Thus the threshold resemblance parameter R can be understood as providing a user-adjustable margin of error parameter that affects whether the two documents are considered nearly duplicative. In one embodiment the threshold resemblance parameter R is between about 0.30 and about 1.00; in another embodiment the threshold resemblance parameter R is between about 0.35 and about 0.75; and in yet another embodiment the threshold resemblance parameter R is between about 0.40 and about 0.60. In one particular embodiment the threshold resemblance parameter R is about 0.50. Given the definition of resemblance in Equation (1), it will be appreciated that r_{w}(A, B)=r_{w}(B, A), and therefore a second calculation of the resemblance of existing Document B with newly-received Document A is unnecessary.

The likelihood that newly-received Document A is contained within existing Document B can be quantified by the parameter c_{w}(A, B), as provided in Equation (2). Similarly, the likelihood that existing Document B is contained within newly-received Document A can be quantified by the parameter c_{w}(B, A), as provided in Equation (3). If the containment value c_{w}(A, B) is greater than a threshold containment parameter C_{AB}, then Documents A and B can be considered to be nearly duplicative of each other. See reference numeral 1124 in FIG. 3B. Likewise, if the containment value c_{w}(B, A) is greater than a threshold containment parameter C_{BA}, then Documents A and B can also be considered to be nearly duplicative of each other. See reference numeral 1126 in FIG. 3B. In one embodiment C_{AB}=C_{BA}, although in other embodiments different threshold parameters can be established for the different containment values MA, B) and c_{w}(B, A). The threshold containment parameters C_{AB}, C_{BA} can be selected based on the demands of a particular application, wherein a smaller value C_{AB}, C_{BA} will result in a lower threshold for establishing that Document A is contained within Document B or vice-versa. Thus the threshold containment parameters C_{AB}, C_{BA} can be understood as providing a user-adjustable margin of error parameter that affects whether the two documents are considered nearly duplicative. In one embodiment the threshold containment parameters C_{AB}, C_{BA} are between about 0.30 and about 1.00; in another embodiment the threshold containment parameters C_{AB}, C_{BA} are between about 0.35 and about 0.75; and in yet another embodiment the threshold containment parameters C_{AB}, C_{BA} are between about 0.40 and about 0.60. In one particular embodiment the threshold containment parameters C_{AB}, C_{BA} are about 0.50. In another particular embodiment R=C_{AB}=C_{BA}.

If at least one of the conditions {r(A, B)>R or c(A, B)>C_{AB} or c(B, A)>C_{BA}} is true, then newly-added Document A can be considered to be nearly duplicative of existing Document B. In this case, timeline administration module 140 can be configured to add Document A to timeline T_{m′} by adding the data pair {S(A, w), T_{m′}} to timeline repository 170. See reference numeral 1140 in FIG. 3B. The “Included in Timeline” parameter associated with Document A can then be set to “true”. See reference numeral 1142 in FIG. 3B. Where Document A has been added to timeline T_{m′} it is unnecessary to compare Document A to the other documents included in timeline T_{m′} and therefore the analysis can proceed to the next timeline stored in timeline repository 170 by incrementing timeline counting parameter m′ by one. See reference numeral 1118 in FIG. 3B. If, on the other hand, none of the conditions {r(A, B)>R or c(A, B)>C_{AB} or c(B, A)>C_{BA}} are true, then newly-added Document A cannot be considered to be nearly duplicative of existing Document B. In this case, the analysis can proceed to the next document included in timeline T_{m′} by incrementing document counting parameter n′ by one. See reference numeral 1128 in FIG. 3B.

Thus the example method 1100 illustrated in FIGS. 3A and 3B for adding a new document to document repository 160 can be understood as comprising two nested iterative cycles. One iterative cycle, based on document counting parameter n′, compares the existing documents in a given timeline to a newly-received document. See reference numerals 1116 and 1128 in FIG. 3B. If an existing document is found to be nearly duplicative to the newly-received document, this iterative cycle can be terminated. See reference numeral 1142 in FIG. 3B. Another iterative cycle, based on timeline counting parameter m′, causes the documents in each timeline stored in timeline repository 170 to be analyzed. See reference numerals 1110 and 1118 in FIGS. 3A and 3B.

Once at least one document in each of the m timelines has been analyzed, it can be determined whether the “Included in Timeline” parameter associated with Document A is set to “true”. See reference numeral 1150 in FIG. 3A. If this is the case, this signifies that Document A is nearly duplicative of an existing document referred to in timeline repository 170, and that Document A has already been added to at least one existing timeline. In such case it is unnecessary to generate a new timeline for Document A. However, if the “Included in Timeline” parameter associated with Document A is still set to “false”, this signifies that Document A is not nearly duplicative of any of the existing documents referred to in timeline repository 170, and that Document A was not added to any existing timeline. In such case timeline administration module 140 can be configured to define a new timeline Tₘ₊₁. See reference numeral 1152 in FIG. 3A. Document A can then be added to new timeline Tₘ₊₁ by adding the data pair {S(A, w), Tₘ₊₁} to timeline repository 170. See reference numeral 1154 in FIG. 3A.

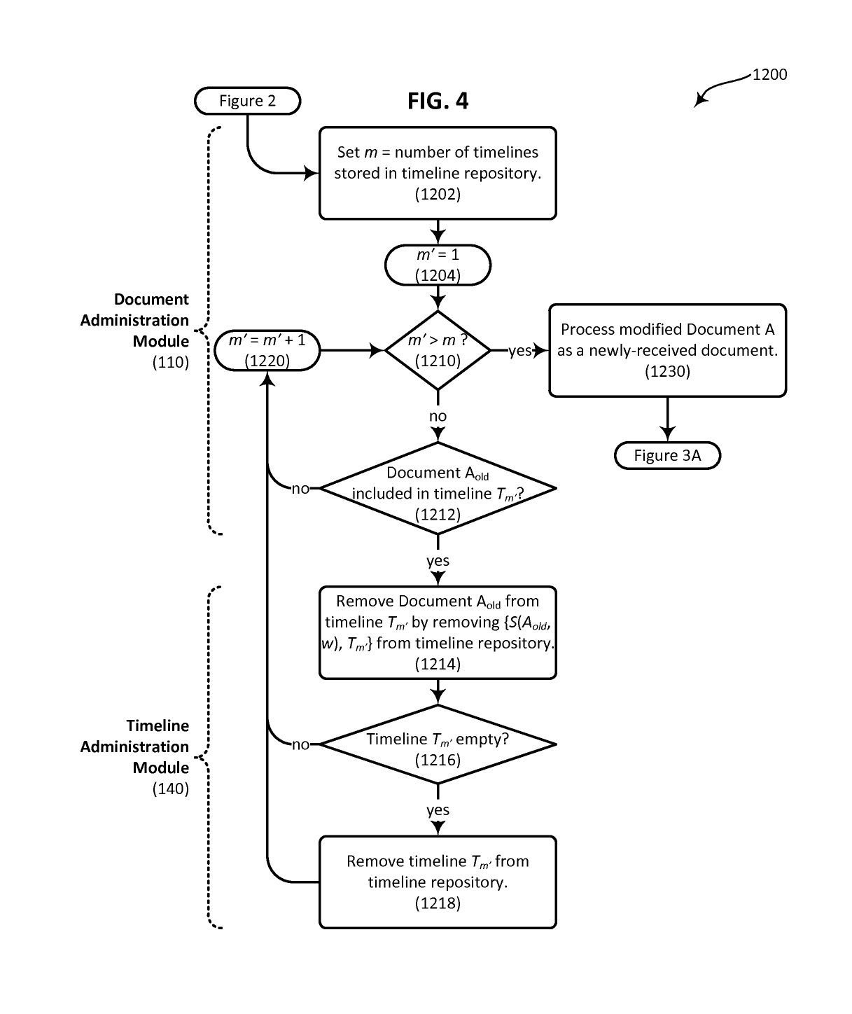

FIG. 4 is a flowchart illustrating an example method 1200 for adding a modified version of a document to document repository 160, wherein document management system 100 is configured to maintain a revision history timeline for documents stored in document repository 160. In the context of method 1200, an existing document that is stored in document repository 160, and that is included in at least one timeline stored in timeline repository 170, will be referred to as “Document A_{old}”. A modified version of Document A_{old} will be referred to as “Document A′”. Thus method 1200 may be invoked, for example, where a user checks-out Document A_{old} from document repository 160, modifies it using resources available to client computing system 200, and then attempts to check-in the resulting modified Document A.

As described in conjunction with method 1100, timeline repository 170 can be understood as storing m distinct timelines. See reference numeral 1202 in FIG. 4. To enable stepwise analysis of the timelines stored in timeline repository 170, the quantity m can be compared to a timeline counting parameter m′ which is initially set such that m′=1. See reference numeral 1204 in FIG. 4. It can then be determined whether m′>m. See reference numeral 1210 in FIG. 4. If not, it can be determined whether existing Document A_{old} is included in timeline T_{m′}. See reference numeral 1212 in FIG. 4. If not, the analysis can proceed to the next timeline stored in timeline repository 170 by incrementing timeline counting parameter m′ by one. See reference numeral 1220 in FIG. 4. In one embodiment such determinations are made by document administration module 110.

On the other hand, if existing Document A_{old} is included in timeline T_{m′}, timeline administration module 140 can be configured to remove Document A_{old} from timeline T_{m′} by removing the data pair {S(A_{old}, w), T_{m′}} from timeline repository 170. See reference numeral 1214 in FIG. 4. It can then be determined whether timeline T_{m′} is empty. See reference numeral 1216 in FIG. 4. If not, the analysis can proceed to the next timeline stored in timeline repository 170 by incrementing timeline counting parameter m′ by one. See reference numeral 1220 in FIG. 4. However, if timeline T_{m′} is empty, this empty timeline can be removed from timeline repository 170. See reference numeral 1218 in FIG. 4. The analysis can then proceed to the next timeline stored in timeline repository 170 by incrementing timeline counting parameter m′ by one. See reference numeral 1220 in FIG. 4. Such iteration continues until the m timelines stored in timeline repository 170 have been processed, that is, until m′>m. See reference numeral 1210 in FIG. 4. This ensures that existing Document A_{old} is removed from existing timelines, given that Document A_{old} has been replaced by modified Document A. Once Document A_{old} has been removed from existing timelines, modified Document A can be processed as a newly received document, as illustrated in FIGS. 3A and 3B. See reference numeral 1230 in FIG. 4. Thus, in such embodiments newer and older versions of the same document do not appear on the same timeline.

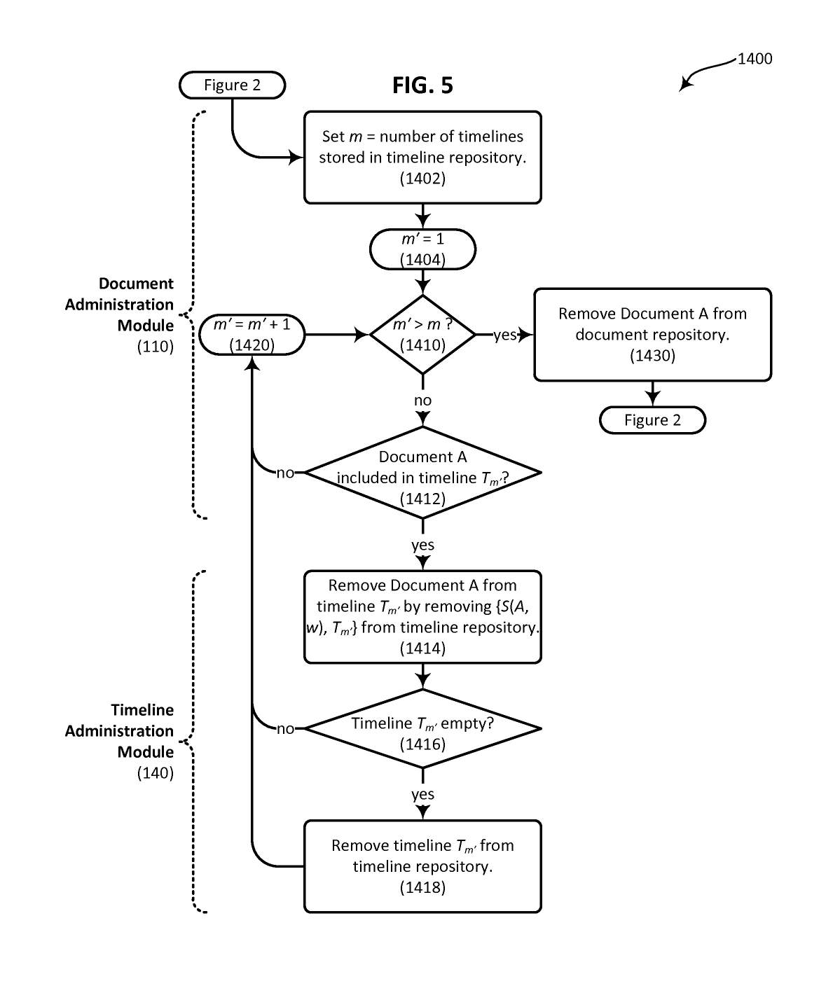

FIG. 5 is a flowchart illustrating an example method 1400 for deleting a document from document repository 160, wherein document management system 100 is configured to maintain a revision history timeline for documents stored in document repository 160. In the context of method 1400, the document to be removed will be referred to as “Document A”. As described in conjunction with method 1100, timeline repository 170 can be understood as storing m distinct timelines. See reference numeral 1402 in FIG. 5. To enable stepwise analysis of the timelines stored in timeline repository 170, the quantity m can be compared to a timeline counting parameter m′ which is initially set such that m′=1. See reference numeral 1404 in FIG. 5. It can then be determined whether m′>m. See reference numeral 1410 in FIG. 5. If not, it can be determined whether Document A is included in timeline T_{m′}. See reference numeral 1412 in FIG. 5. If not, the analysis can proceed to the next timeline stored in timeline repository 170 by incrementing timeline counting parameter m′ by one. See reference numeral 1420 in FIG. 5. In one embodiment such determinations are made by document administration module 110.

On the other hand, if existing Document A is included in timeline T_{m′}, timeline administration module 140 can be configured to remove Document A from timeline T_{m′} by removing the data pair {S(A, w), T_{m′}} from timeline repository 170. See reference numeral 1414 in FIG. 5. It can then be determined whether timeline T_{m′} is empty. See reference numeral 1416 in FIG. 5. If not, the analysis can proceed to the next timeline stored in timeline repository 170 by incrementing timeline counting parameter m′ by one. See reference numeral 1420 in FIG. 5. However, if timeline T_{m′} is empty, this empty timeline can be removed from timeline repository 170. See reference numeral 1418 in FIG. 5. The analysis can then proceed to the next timeline stored in timeline repository 170 by incrementing timeline counting parameter m′ by one. See reference numeral 1420 in FIG. 5. Such iteration continues until the m timelines stored in timeline repository 170 have been processed, that is, until m′>m. See reference numeral 1410 in FIG. 5. This ensures that Document A is removed from existing timelines. Once this is accomplished document administration module 110 can be used to remove Document A from document repository 160. See reference numeral 1430 in FIG. 4.

Referring again to FIG. 2, it will be appreciated that the received user command results in manipulation of a content-based revision history timeline. For example, when a new or modified document is received, timeline administration module 140 can be configured to add the document to an existing timeline or a new timeline. See reference numeral 1140 in FIG. 3B or reference numeral 1154 in FIG. 3A, respectively. In the case of a removed document, timeline administration module 140 can be configured to remove the document from an existing timeline. See reference numeral 1214 in FIG. 4. In either case it may be desired to generate a received timeline based on the modifications. Thus in certain embodiments method 1000 further comprises using timeline generation module 150 to generate a new content-based revision history timeline based on the revised status of the documents included in the timeline. See reference numeral 1500 in FIG. 2. Timeline generation module 150 can also be configured to send the new timeline to client computing system 200 for display. See reference numeral 1600 in FIG. 2. In certain embodiments the timeline is displayed in response to a user request to perform an action with respect to a document included in the timeline, such as a document check-in operation, a document check-out operation, a document modification operation, or a document transmission operation.

FIG. 6 illustrates three intersecting content-based revision history timelines T₁, T₂, T₃ such as may be generated using certain of the techniques disclosed herein. In particular, timeline T₁ includes Documents A, C, F, and K; timeline T₂ includes Documents B, D, E, and I; and timeline T₃ includes Documents G, H, J, and L. The documents included in a given revision history timeline can be arranged according to a time-based parameter, such as a document modification time, a document generation time, or a document check-in time. Other parameters can be used in other embodiments, including non-time-based parameters. In one embodiment documents are positioned in the revision history timeline based on metadata corresponding to such documents. Such data may be present, for example, in document repository 160. The content-based revision history timelines disclosed herein can be rendered as part of graphical user interface 282 based on data generated by timeline generation module 150.

It is possible to infer a sequence of document history revision events from a revision history timeline generated according to certain of the embodiments disclosed herein. For example, as can be inferred from the example timelines illustrated in FIG. 6, new Documents A and B were added to document repository 160, but were not found to be nearly duplicative of any existing documents. Therefore new timelines T₁ and T₂ were created for new Documents A and B, respectively. New Document D was then added to document repository 160, and because it was found to resemble existing Document B, it was also added to timeline T₂. New Document G was then added to document repository 160, but was not found to be nearly duplicative of any existing documents. Therefore new timeline T₃ was created for new Document G. New Document C was then added to document repository 160, and because it was found to resemble existing Document A, it was added to timeline T₁. New Document E was then added to document repository 160, and because it was found to resemble Document D and contain Document C, links to both Timelines T₁ and T₂ were established. This process of adding new documents, generating new timelines and linking existing timelines can continue as appropriate. Timeline intersections, such as are generated by the addition of Documents E, I, and L in FIG. 6, indicate that particular content is understood to have origins in multiple different documents. In a modified embodiment, the timeline includes notations that reflect certain special relationships between documents, such as two documents that expressly refer to each other, or two documents which are exact duplicates of each other. In yet another embodiment, a user may remove or create customized timeline links between two documents; this may be useful where a user wishes to disregard a detected relationship between two documents, or where a user wishes to establish a relationship between two documents based on something other than the resemblance and containment parameters disclosed herein.

Thus, in general, certain of the embodiments disclosed herein result in one or more revision history timelines that trace the evolution of content regardless of whether the content evolves via importing a newly introduced document or revising an existing document. The timelines in which a given document is included indicate the different content versions added to document repository 160. Multiple documents can be organized into different timelines depending on which documents are nearly duplicative of each other, as defined herein. Within a single timeline, multiple documents can be arranged according to a time-based parameter such as may be extracted from document metadata. For newly created documents, the time-based parameter can be taken as the time the document was created, or if that is unavailable, the time the document was added to document repository 160. This may be, for example, the time a document was uploaded to a cloud-based repository or the time a document was sent or received via email. For documents already existing in document repository 160, the time-based parameter can be taken as the most recent modification time.

### CONCLUSION

The various embodiments disclosed herein advantageously enable the generation and maintenance of content-based revision history timelines for content managed by a document management server. This is particularly advantageous in the context of workflows where users produce multiple versions of a single document when creating and working with content. For example, a user may have an idea for a proposal at home on a weekend. He makes a note in a text file and saves it to an online cloud repository or emails it to his work email account. Upon arriving at the office on Monday, he draws up a proposal using a word processor, exports the file to a portable document format, and shares it with colleagues by using a file sharing service or email. His colleagues add their comments to the shared file, or to the emailed files. The marked-up files are then returned to the first user who incorporates the comments as appropriate and sends a final version to multiple clients. In this example workflow multiple documents containing different versions of the same content are created. If the user wishes to refer to any one of these versions some time later, he may find it difficult to understand the relationship between the versions unless he has carefully saved and indexed them in an organized way. Certain of the embodiments disclosed herein provide an automated way to achieve such organization without requiring user diligence. For example, the content-based revision history timelines disclosed herein provide an automatically-generated collection of documents that have a common origin, even though they may slightly differ from each other or they may represent different stages in the development of the same content. This provides the end user with a better understanding of how the content within different documents relates to each other, thus moving away from traditional document-based management techniques.

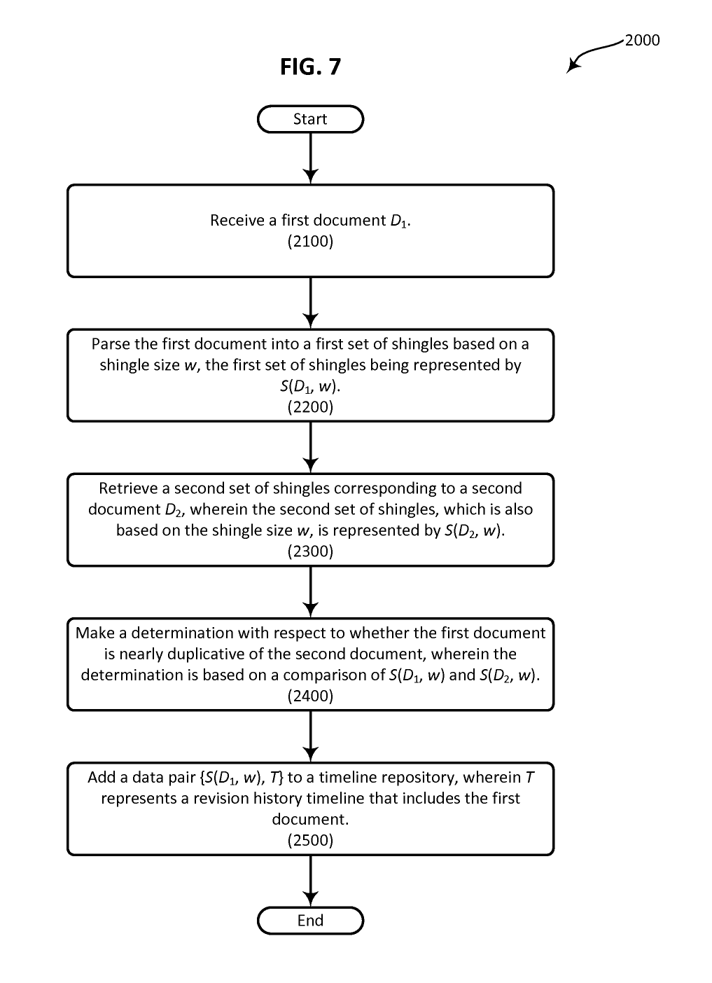

Numerous variations and configurations will be apparent in light of this disclosure. For instance, as illustrated in FIG. 7, one example embodiment provides a method 2000 for tracking content revision history. Method 2000 comprises receiving a first document D₁. See reference numeral 2100 in FIG. 7. Method 2000 further comprises parsing the first document into a first set of shingles based on a shingle size w, wherein the first set of shingles is represented by S(D₁, w). See reference numeral 2200 in FIG. 7. Method 2000 further comprises retrieving a second set of shingles corresponding to a second document D₂, wherein the second set of shingles, which is also based on the shingle size w, is represented by S(D₂, w). See reference numeral 2300 in FIG. 7. Method 2000 further comprises making a determination with respect to whether the first document is nearly duplicative of the second document, wherein the determination is based on a comparison of S(D₁, w) and S(D₂, w). See reference numeral 2400 in FIG. 7. Method 2000 further comprises adding a data pair {S(D₁, w), T} to a timeline repository, wherein T represents a revision history timeline that includes the first document. See reference numeral 2500 in FIG. 7. In some cases the first document is received in conjunction with a command to check the first document into a document repository. In some cases, in response to making a determination that the first document is nearly duplicative of the second document, the method further comprises causing the data pair {S(D₁, w), T₁₂} to be added to the timeline repository, wherein T₁₂ represents a revision history timeline that includes the first and second documents. In some cases the timeline repository includes data pairs that collectively correlate a plurality of documents with a particular revision history timeline. In some cases the timeline repository includes a particular set of shingles which is correlated with a plurality of different revision history timelines. In some cases (a) the first document is received in conjunction with a command originating from a user to check the first document into a document repository; and (b) the method further comprises (i) generating a graphical representation of the revision history timeline based on data extracted from the timeline repository, and (ii) sending the graphical representation of the revision history timeline to the user. In some cases the method further comprises (a) receiving a command to remove a third document D₃ from a document repository; and (b) removing a data pair {S(D₃, w), T} from the timeline repository, wherein S(D₃, w) represents a third set of shingles that are generated from the third document, and wherein T represents a timeline that included the third document upon receipt of the command. In some cases the method further comprises generating a graphical representation of the revision history timeline based on data extracted from the timeline repository, wherein the revision history timeline includes a plurality of documents, each of which is nearly duplicative of another one of the plurality of documents. In some cases the first document is considered to be nearly duplicative of the second document where a resemblance parameter

$${r}_{w} ( {D}_{1} , {D}_{2} ) = \frac{\vert S ( {D}_{1} , w ) ⋂ S ( {D}_{2} , w ) \vert}{\vert S ( {D}_{1} , w ) ⋃ S ( {D}_{2} , w ) \vert} \qquad ( 7 )$$

exceeds a threshold resemblance parameter R. In some cases the first document is considered to nearly duplicative of the second document where at least one of the containment parameter

$$\begin{matrix}{c}_{w} ( {D}_{1} , {D}_{2} ) = \frac{\vert S ( {D}_{1} , w ) ⋂ S ( {D}_{2} , w ) \vert}{\vert S ( {D}_{1} , w ) \vert} & ( 8 ) \\ {c}_{w} ( {D}_{2} , A ) = \frac{\vert S ( {D}_{1} , w ) ⋂ S ( {D}_{2} , w ) \vert}{\vert S ( {D}_{2} , w ) \vert} & ( 9 )\end{matrix}$$

exceeds a threshold containment parameter C.

Another example embodiment provides a system for content revision history tracking that comprises a timeline repository stored in a memory device. The timeline repository includes a plurality of data pairs {S(D, w), T}, wherein D represents a document, T represents a revision history timeline that includes D, and S(D, w) represents a set of shingles that is derived from D and that is based on a shingle size w. The system further comprises a document administration module configured to receive a first document D₁ and a user command with respect to the first document. The system further comprises a content comparison module configured to evaluate a similarity measure between S(D₁, w) and S(D₂, w), wherein D₂ represents a second document that is retrieved from a document repository. The system further comprises a timeline administration module configured to store a data pair {S(D₁, w), T₁₂} in the timeline repository in response to determining that the similarity measure exceeds a predetermined threshold similarity, wherein T₁₂ represents a revision history timeline that includes the first and second documents. In some cases the user command is a command to add the first document to the document repository. In some cases determining that the similarity measure exceeds the predetermined threshold similarity indicates that the first and second documents are nearly duplicative based on a comparison of at least one of resemblance and containment. In some cases shingle size w ranges from about 20 words to about 40 words. In some cases the system further comprises a timeline generation module configured to generate a graphical representation of the revision history timeline T₁₂. In some cases the system further comprises a timeline generation module configured to send a graphical representation of the revision history timeline T₁₂ to a user that originated the user command.

Another example embodiment provides a computer program product encoded with instructions that, when executed by one or more processors, causes a process for tracking content revision history to be carried out. The process comprises receiving a first document containing first content. The process further comprises retrieving a second document containing second content. The second document is not an older version of the first document. The process further comprises making a determination whether the first document is nearly duplicative of the second document based on a comparison of the first and second content. Where the determination indicates that the first and second documents are nearly duplicative of each other, the process further comprises adding a representation of the first document to a timeline repository that already contains a representation of the second document. In some cases (a) the determination is based on evaluating a similarity measure for the first and second documents; and (b) the similarity measure is selected from a group consisting of resemblance and containment. In some cases (a) the second document is retrieved from a document repository managed by a document management system; and (b) the first document is received from a first document source external to the document management system. In some cases the process further comprises generating a graphical representation of the revision history timeline based on data extracted from the timeline repository, wherein the revision history timeline includes a plurality of documents, each of which is nearly duplicative of another one of the plurality of documents.

The foregoing detailed description has been presented for illustration. It is not intended to be exhaustive or to limit the disclosure to the precise form described. Many modifications and variations are possible in light of this disclosure. Therefore it is intended that the scope of the disclosure be limited not by this detailed description, but rather by the claims appended hereto. Subsequently filed applications claiming priority to this application may claim the disclosed subject matter in a different manner, and may generally include any set of one or more features as variously disclosed or otherwise demonstrated herein.

What is claimed is:

1. A method for tracking content revision history, the method comprising:
receiving a first document D₁;
parsing the first document into a first set of shingles based on a shingle size w, the first set of shingles being represented by S(D₁, w);
retrieving a second set of shingles corresponding to a second document D₂, wherein the second set of shingles, which is also based on the shingle size w, is represented by S(D₂, w);
making a determination with respect to whether the first document is nearly duplicative of the second document, wherein the determination is based on a comparison of S(D₁, w) and S(D₂, w); and
adding a data pair {S(D₁, w), T} to a timeline repository, wherein T represents a revision history timeline that includes the first document.

2. The method of claim 1, wherein the first document is received in conjunction with a command to check the first document into a document repository.

3. The method of claim 1, wherein, in response to making a determination that the first document is nearly duplicative of the second document, the method further comprises causing the data pair {S(D₁, w), T₁₂} to be added to the timeline repository, wherein T₁₂ represents a revision history timeline that includes the first and second documents.

4. The method of claim 1, wherein the timeline repository includes data pairs that collectively correlate a plurality of documents with a particular revision history timeline.

5. The method of claim 1, wherein the timeline repository includes a particular set of shingles which is correlated with a plurality of different revision history timelines.

6. The method of claim 1, wherein:
the first document is received in conjunction with a command originating from a user to check the first document into a document repository; and
the method further comprises:
generating a graphical representation of the revision history timeline based on data extracted from the timeline repository, and
sending the graphical representation of the revision history timeline to the user.

7. The method of claim 1, further comprising:
receiving a command to remove a third document D₃ from a document repository; and
removing a data pair {S(D₃, T), w} from the timeline repository, wherein S(D₃, T) represents a third set of shingles that are generated from the third document, and wherein T represents a timeline that included the third document upon receipt of the command.

8. The method of claim 1, further comprising generating a graphical representation of the revision history timeline based on data extracted from the timeline repository, wherein the revision history timeline includes a plurality of documents, each of which is nearly duplicative of another one of the plurality of documents.

9. The method of claim 1, wherein the first document is considered to be nearly duplicative of the second document where a resemblance parameter
$${r}_{w} ( {D}_{1} , {D}_{2} ) = \frac{\vert S ( {D}_{1} , w ) ⋂ S ( {D}_{2} , w ) \vert}{\vert S ( {D}_{1} , w ) ⋃ S ( {D}_{2} , w ) \vert}$$
exceeds a threshold resemblance parameter R.

10. The method of claim 1, wherein the first document is considered to be nearly duplicative of the second document where at least one of the containment parameters
$$\begin{matrix}{c}_{w} ( {D}_{1} , {D}_{2} ) = \frac{\vert S ( {D}_{1} , w ) ⋂ S ( {D}_{2} , w ) \vert}{\vert S ( {D}_{1} , w ) \vert} \\ {c}_{w} ( {D}_{2} , A ) = \frac{\vert S ( {D}_{1} , w ) ⋂ S ( {D}_{2} , w ) \vert}{\vert S ( {D}_{2} , w ) \vert}\end{matrix}$$
exceeds a threshold containment parameter C.

11. A system for content revision history tracking, the system comprising:
a timeline repository stored in a memory device, the timeline repository including a plurality of data pairs {S(D, w), T}, wherein D represents a document, T represents a revision history timeline that includes D, and S(D, w) represents a set of shingles that is derived from D and that is based on a shingle size w;
a document administration module configured to receive a first document D₁ and a user command with respect to the first document;
a content comparison module configured to evaluate a similarity measure between S(D₁, w) and S(D₂, w), wherein D₂ represents a second document that is retrieved from a document repository; and
a timeline administration module configured to store a data pair {S(D₁, w), T₁₂} in the timeline repository in response to determining that the similarity measure exceeds a predetermined threshold similarity, wherein T₁₂ represents a revision history timeline that includes the first and second documents.

12. The system of claim 11, wherein the user command is a command to add the first document to the document repository.

13. The system of claim 11, wherein determining that the similarity measure exceeds the predetermined threshold similarity indicates that the first and second documents are nearly duplicative based on a comparison of at least one of resemblance and containment.

14. The system of claim 11, wherein the shingle size w ranges from about 20 words to about 40 words.

15. The system of claim 11, further comprising a timeline generation module configured to generate a graphical representation of the revision history timeline T₁₂.

16. The system of claim 11, further comprising a timeline generation module configured to send a graphical representation of the revision history timeline T₁₂ to a user that originated the user command.

17. A computer program product encoded with instructions that, when executed by one or more processors, causes a process for tracking content revision history to be carried out, the process comprising:
receiving a first document containing first content;
retrieving a second document containing second content, wherein the second document is not an older version of the first document;
making a determination whether the first document is nearly duplicative of the second document based on a comparison of the first and second content; and
where the determination indicates that the first and second documents are nearly duplicative of each other, adding a representation of the first document to a timeline repository that already contains a representation of the second document.

18. The computer program product of claim 17, wherein:
the determination is based on evaluating a similarity measure for the first and second documents; and
the similarity measure is selected from a group consisting of resemblance and containment.

19. The computer program product of claim 17, wherein:
the second document is retrieved from a document repository managed by a document management system; and
the first document is received from a first document source external to the document management system.

20. The computer program product of claim 17, wherein the process further comprises generating a graphical representation of the revision history timeline based on data extracted from the timeline repository, wherein the revision history timeline includes a plurality of documents, each of which is nearly duplicative of another one of the plurality of documents.
